(19) United States
(12) Patent Application Publication
(10) Pub. No.: US 2013/0321394 A1
(43) Pub. Date: Dec. 5, 2013

(54) THREE-DIMENSIONAL DISPLAY DEVICE, SYSTEM FOR CREATING THREE-DIMENSIONAL DISPLAY, AND PROCESS OF CREATING THREE-DIMENSIONAL DISPLAY

(71) Applicants: Mark Eliott FISHER, London (GB); Frederic Frank OPSOMER, Kortemark (BE)

(72) Inventors: Mark Eliott FISHER, London (GB); Frederic Frank OPSOMER, Kortemark (BE)

(73) Assignee: TAIT TECHNOLOGIES, INC., Waardamme (BE)

(21) Appl. No.: 13/591,400

(22) Filed: Aug. 22, 2012

(30) Foreign Application Priority Data
Jun. 5, 2012 (BE) 2012/0374

(51) Int. Cl. G06T 15/00

(52) U.S. Cl. 345/419

(57) ABSTRACT

Disclosed is a three-dimensional display device, a system for creating a three-dimensional display, and a process of creating a three-dimensional display. The three-dimensional display device includes a rotatable portion and a plurality of light emitting elements connected to the rotatable portion. Rotation of the rotatable portion rotates the light emitting elements and displays a sequence of images corresponding with segmented image data as an illusion of a continuous three-dimensional image. The system includes an array arranged and disposed to gather segmented image data and a display arranged and disposed to display a sequence of images corresponding with the segmented image data. The displaying forms an illusion of a continuous three-dimensional image. The process includes gathering segmented image data and displaying a sequence of images corresponding with the segmented image data. The displaying forms an illusion of a continuous three-dimensional image.

### FIELD OF THE INVENTION

The present invention is directed to display devices, display systems, and display processes. More specifically, the present invention is directed to three-dimensional visual display.

### BACKGROUND OF THE INVENTION

It is well known since before the days of motion pictures that one can create an illusion of a moving image by the display of a rapid succession of still images. A number of drawbacks exist with the creation of the illusion of motion from a sequence of still images. For example, as discussed in U.S. Pat. No. 4,698,682, which is hereby incorporated by reference in its entirety, graphic images can appear jerky if the size and speed at which pixels change are perceived by a viewer. Removing the jerkiness can involve decreasing pixel size or increasing the rate at which still images are displayed, either of which can be expensive and impracticable, for example, due to the large amount of data to be gathered and utilized. To resolve such drawbacks, a known technique is to morph the color of individual pixels, thereby rendering the transition imperceptible. However, creating an illusion of a three-dimensional moving image exacerbates the complications.

The amount of data associated with a three-dimensional image is much greater than that associated with a two-dimensional image. A known technique described in U.S. Pat. No. 4,946,045, which is hereby incorporated by reference in its entirety, shows a method and apparatus for collecting such data. For example, the technique includes a concentric arrangement of electronic viewers in a single plane each at the same angle with an unobscured view of an object. The electronic viewers collect data of the object, such as, geometry, amount of transparency, amount of translucency, amount of refractivity, and amount of reflectivity. Based upon the gathered data the apparatus sorts the objects.

Use of the electronic viewers to collect data results in segmented data. The segmented data does not include information from certain unanalyzed regions within the concentric arrangement of electronic viewers. The unanalyzed regions are between each of the electronic viewers. Generally, the arrangement of the electronic viewers is such that the unanalyzed regions do not include the object and, thus, the data gathered is adequate at characterizing the object. However, use of the data collection technique for display purposes has not been done and is limited due to the existence of the unanalyzed regions. In addition, the data collected is segmented because it comes from separate electronic viewers positioned around the object instead of a single electronic viewer.

The segmentation can be avoided by moving a single data collection device, for example, in a circle around an object. However, use of the single data collection device is incapable of gathering data from the far side of the object when the object obstructs such a view. Thus, such techniques have limited applicability when used for gathering data of objects in motion. Segmentation of data collected does permit formation of three-dimensional displays but has required complex methods and systems for using the data. For example, U.S. Pat. No. 5,613,048, which is hereby incorporated by reference in its entirety, shows data collection resulting in segmented data of a three-dimensional object. The data collected is morphed and/or interpolated to render a three-dimensional display of the object complete. Without the morphing and/or interpolating, the object would have missing and/or unmatched segments when displayed.

A three-dimensional display device, a system for creating a three-dimensional display, and a process of creating a three-dimensional display, that do not suffer from one or more of the above drawbacks would be desirable in the art.

### BRIEF DESCRIPTION OF THE INVENTION

In an exemplary embodiment, a three-dimensional display device includes a rotatable portion and a plurality of light emitting elements connected to the rotatable portion. Rotation of the rotatable portion rotates the light emitting elements, thereby displaying an illusion of a three-dimensional image corresponding to a sequence of segmented images.

In another exemplary embodiment, a system for creating a three-dimensional display includes an array arranged and disposed to gather segmented image data and a display arranged and disposed to display a sequence of images corresponding with the segmented image data. The displaying forms an illusion of a three-dimensional image.

In another exemplary embodiment, a process of creating a three-dimensional display includes gathering segmented image data and displaying a sequence of images corresponding with the segmented image data. The displaying forms an illusion of a three-dimensional image.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an exemplary three-dimensional display device according to the disclosure.

FIG. 2 is a perspective view of an exemplary three-dimensional display device rotating.

FIG. 3 is a perspective view of an exemplary three-dimensional display device rotating according to an exemplary process of creating a three-dimensional display according to the disclosure.

FIG. 4 is a perspective view of an exemplary three-dimensional display device rotating according to an exemplary process of creating a three-dimensional display according to the disclosure.

FIG. 5 is a schematic view of a segmented display of a three-dimensional object captured by an exemplary system for creating three-dimensional display according to the disclosure.

FIG. 6 is a top view of image data of a three-dimensional object being captured by an exemplary system for creating three-dimensional display according to the disclosure.

FIG. 7 is a perspective view of an exemplary protruding member of a three-dimensional display device rotating according to the disclosure.

FIG. 8 is a perspective view of an exemplary three-dimensional display device according to the disclosure.

FIG. 9 is a perspective view of an exemplary three-dimensional display device according to the disclosure.

FIG. 10 is a schematic view of an exemplary system and process for three-dimensional display according to the disclosure.

FIG. 11 is a perspective view of an exemplary three-dimensional display device according to the disclosure.

FIG. 12 is a partial perspective view of an exemplary three-dimensional display device according to the disclosure.

FIG. 13 is a partial perspective view of an exemplary three-dimensional display device according to the disclosure.

Wherever possible, the same reference numbers will be used throughout the drawings to represent the same parts.

### DETAILED DESCRIPTION OF THE INVENTION

Provided is a three-dimensional display device, a system for creating a three-dimensional display, and a process of creating a three-dimensional display. Embodiments of the present disclosure create an illusion of a three-dimensional image, create an illusion of three-dimensional movement of an object, permit moving images to be displayed in three-dimensions, reduce or eliminate segmentation of three-dimensional images, reduce or eliminate jerkiness, utilize simpler lighting systems and/or fewer pixels, rely upon low amounts of data in comparison to prior three-dimensional image display techniques, reduce or eliminate manipulation and/or conversion of data in comparison to prior three-dimensional image display techniques, permit viewing of three-dimensional images from multiple and/or all directions, or combinations thereof.

Referring to FIG. 1, a three-dimensional display device 100 is shown. The three-dimensional display device 100 includes an arrangement of light emitting elements 102, such as video strips, light emitting diodes, organic light emitting diodes, fiber optic lights, fluorescent lights, incandescent lights, neon lights, or combinations thereof. In one embodiment, each of the light emitting elements 102 includes a predetermined number of pixels per inch, for example, between 1 and 100, between 1 and 10, between 1 and 20, between 10 and 20, between 5 and 10, between 3 and 8, between 10 and 50, between 10 and 30, between 30 and 50, between 20 and 40, between 1 and 5, or any suitable combination or sub-combination thereof. The arrangement of pixels is substantially uniform or non-uniform along the light emitting elements 102. In one embodiment, the density of pixels is greater at portions of the light emitting element 102 that are to rotate at a higher rate during rotation of the three-dimensional display device 100 (for example portions farthest from a central location of the three-dimensional display device 100).

The light emitting elements 102 are powered from a local power source, such as a battery, and/or are powered by an external power source, for example, positioned in a non-moving portion 108 of the three-dimensional display device 100 but in electrical communication with the light emitting elements 102. Likewise, the light emitting elements 102 are controlled by a local controller and/or are controlled by an external controller, for example, positioned in the non-moving portion 108 of the three-dimensional display device 100 but in communication with the light emitting elements 102.

The light emitting elements 102 are a single unitary construction capable of providing a range of colored light and/or a range of intensity of light or a combined construction capable of providing the range of colored light and/or the range of intensity of light. In one embodiment, the light emitting elements 102 are devoid of any additional structural components other than the light emitting elements 102 and also serve as a structural member, such as, a protruding member 104. In another embodiment, as shown in FIG. 7, the light emitting elements 102 are positioned along the protruding member 104 providing structural support and/or resilience. In a further embodiment, a plurality of the light emitting elements 102 are positioned on the protruding member 104, for example, with the protruding member 104 having a cuboid geometry and the light emitting elements 102 being positioned on various surfaces of the protruding member 104. In one embodiment, the light emitting elements 102 are positioned on opposite surfaces of the protruding members 104. In one embodiment, the light emitting elements 102 and/or protruding members 104 are of different lengths (see FIG. 11).

The light emitting elements 102 extend from a central location, such as along a rotatable portion 106, for example, an elongate member, capable of rotation at high velocities (for example, velocities capable of creating an illusion of a continuous image by rotation of the light emitting elements 102) as is shown in FIGS. 1-4 and 8-10 or inward from the rotatable portion, for example, a rotatable cover 304, as is shown in FIG. 11. In one embodiment, the non-moving portion 108 includes suitable devices configured to provide rotation to rotatable portion 106 or rotatable cover 304, such as motors or gears, for example. Referring to FIGS. 1-4 and 8-11, in some embodiments, the light emitting elements 102 are fixedly secured to the rotatable portion 106 and extend in a rigid manner from the rotatable portion 106, for example, by fasteners 110, such as a clipping mechanism, a threaded feature, a welding, soldering, bolts, adhesives, interference fits, or other suitable engagement mechanisms. For example, FIG. 11 shows an embodiment with the rotatable portion 106 being the cover 304 and the light emitting elements 102 and/or protruding members 104 extending inward from the cover 304 in a rigid manner.

Referring to FIGS. 1-4 and 8-10, in other embodiments, the light emitting elements 102 are flexibly secured to the rotatable portion 106. In these embodiments, when the rotatable portion 106 is not rotating, all or a portion of one or more of the light emitting elements 102 hang in a downward direction, for example, toward or away from the non-moving portion 108, depending upon gravity and the orientation of the non-moving portion 108 in relation to the rotatable portion 106. As the rotatable portion 106 rotates, the light emitting elements 102 begin to rotate and extend from the rotatable portion 106, for example, perpendicular to the rotatable portion 106 and/or gravity, or to a display position at any suitable angle relative to same, or combination thereof. In one embodiment, the fasteners 110 are configured for any suitable rotatable connection to the rotatable portion 106, such as a ball joint, for example. During rotation of the rotatable portion 106, the hanging light emitting elements 102 or the hanging protruding members 104 pivot swing upward into the display position during rotation of rotatable portion 106.

Referring to FIGS. 2, upon rotation of the rotatable portion 106, the light emitting elements 102 form a segmented image 202. The segmented image 202 includes regions where portions of an image are visible and regions where no image is visible. The position and size of these regions depends upon the size of the rotatable portion 106, the size of the protruding members 104, the amount of the protruding members 104 included, the size and position of the light emitting elements 102, the brightness and color of the light emitting elements 102, and other features and properties affecting the formation of the segmented image 202.

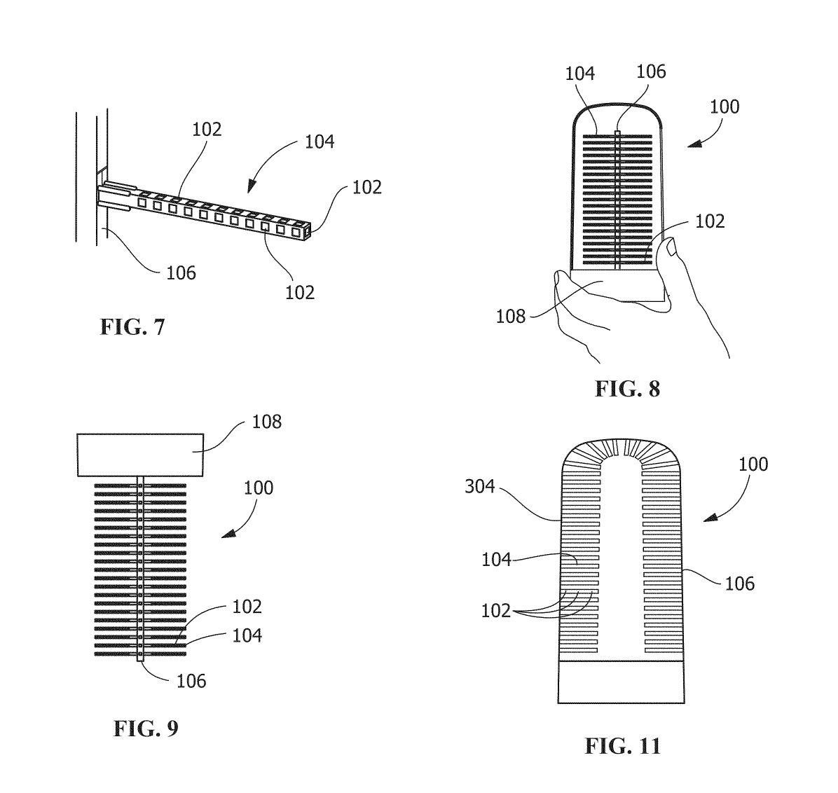

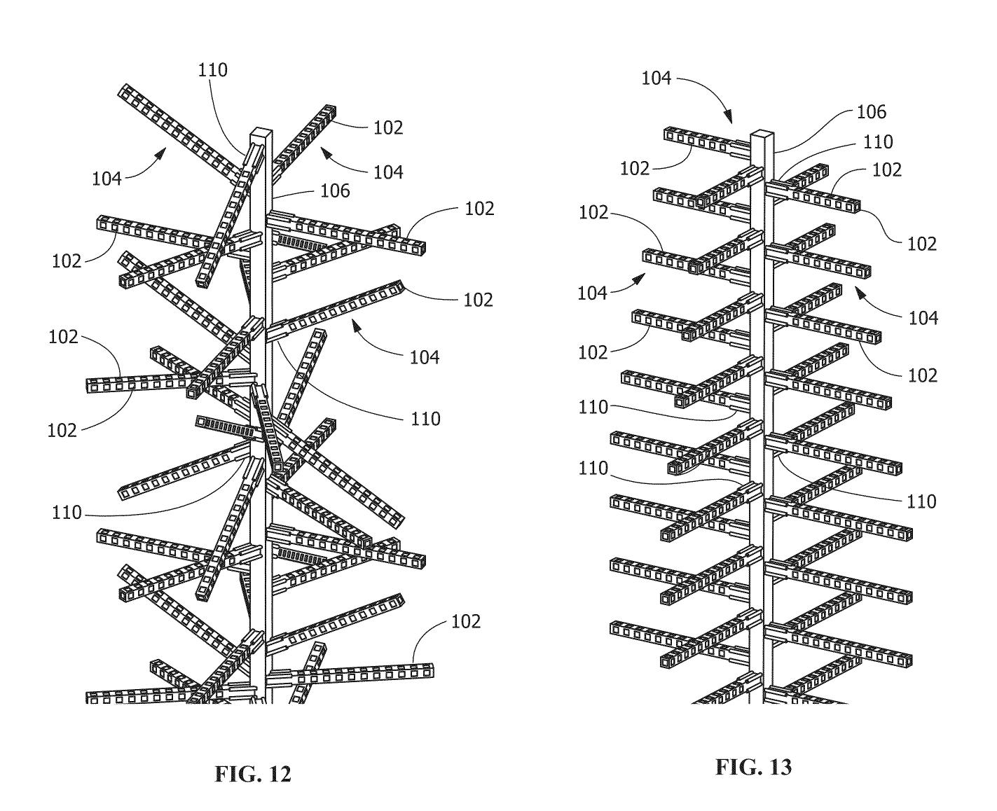

In one embodiment, the protruding members 104 are arranged in a substantially uniform orientation around the rotatable portion 106 (see FIGS. 8, 9 and 13) in a predetermined pattern including three or more position parameters, such as equally spaced distribution vertically, equally spaced or equal polar angle horizontal distribution, and equal connection or display angle relative to the central vertical axis of the rotatable portion 106. Referring to FIG. 13, in one embodiment, each of the protruding members 104 are equally spaced in vertical distribution relative to the adjacent member, are at equal polar angle distribution relative to the adjacent member (about 90 degrees), and are positioned at the same display angle relative to the central vertical axis of the rotatable portion 106 (about 90 degrees). In one embodiment, the protruding members 104 are arranged in a non-uniform arrangement (see FIGS. 1 and 12). In a non-uniform arrangement embodiment, any one of the three position parameters can vary, such as vertical spacing, horizontal spacing or polar angle, or display angle relative to the central vertical axis of the rotatable portion 106, or a combination thereof. Referring to FIG. 12, in one embodiment, all three position parameters are varied, to provide varying relative positions of the protruding members 104. In one embodiment, one or more of the protruding members 104 are either flexibly, rigidly, or a combination of flexibly and rigidly secured. In one embodiment, the protrusions are arranged in a staggered orientation permitting viewing of light from the light emitting elements 102 that would otherwise be obstructed.

The protruding members 104 extend at any suitable angle or angles from the rotatable portion 106. Suitable angles include, but are not limited to, 0 degrees (for example, perpendicular to the rotatable portion 106), 5 degrees upward (opposite the direction of gravity), 10 degrees upward, 20 degrees upward, 30 degrees upward, 5 degrees downward (along the direction of gravity), 10 degrees downward, 20 degrees downward, 30 degrees downward, or any range within. In one embodiment, all of the protruding members 104 extend at substantially the same angle from the rotatable portion 106. In another embodiment, some (but not all) of the protruding members 104 extend at substantially the same angle from the rotatable portion 106. In another embodiment, each of the protruding members 104 extends at a different angle from the rotatable portion 106. In one embodiment, the amount of the protruding members 104 included and the angle of each of the protruding members 104 is determined based upon the features of the rotatable portion 106, the light emitting elements 102 utilized, and rates and quantity of data transmitted to the three-dimensional display device 100 for a display to be shown.

The segmented image 202 appears segmented until the rotation of the rotatable portion 106 exceeds a predetermined rate, as is shown in FIG. 3, and an illusion of a complete three-dimensional image 302 is formed. The predetermined rate is specific to the three-dimensional display device 100 and arrangement and/or structure of the rotatable portions 106 in the three-dimensional display device 100. For example, the predetermined rate corresponds to one or more of the size of the rotatable portion 106, the amount of the rotatable portions 106 included, the size and position of the light emitting elements 102, the brightness and color of the light emitting elements 102, features of the three-dimensional image 302 formed (such as, brightness, geometry, complexity, dimensions, colors, and combinations thereof), environmental factors (such as, brightness, shadowing, temperature, wind, precipitation such as rain or snow, external lighting, or combinations thereof), or other suitable features or conditions.

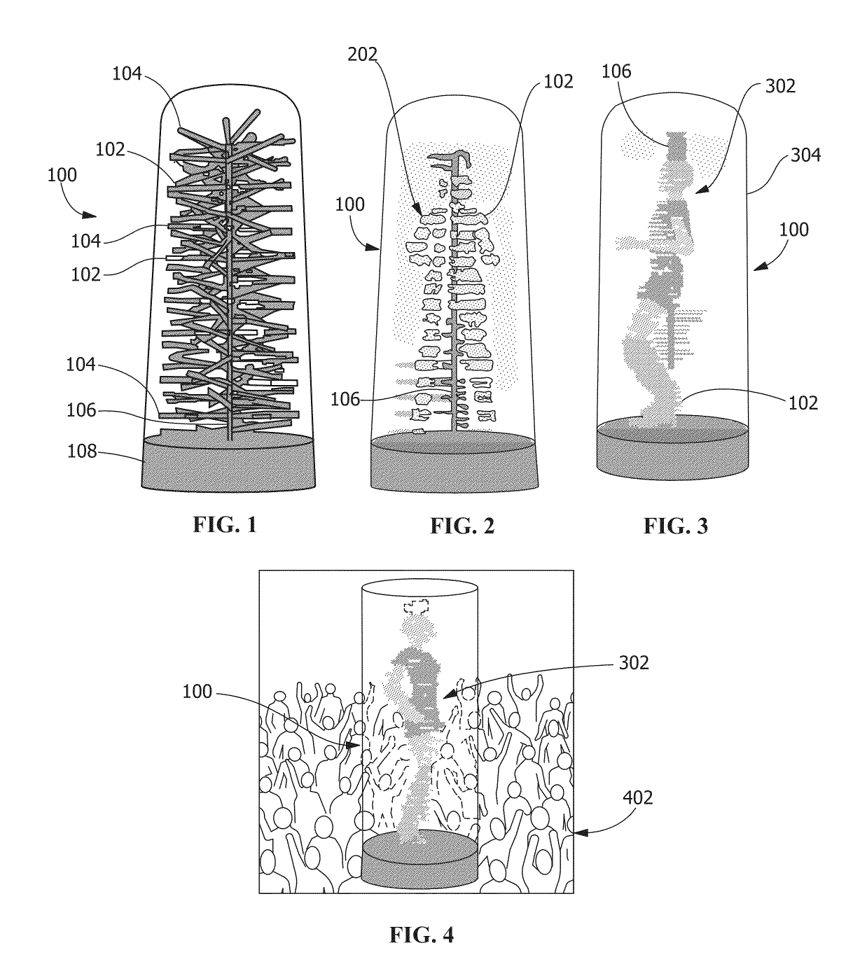

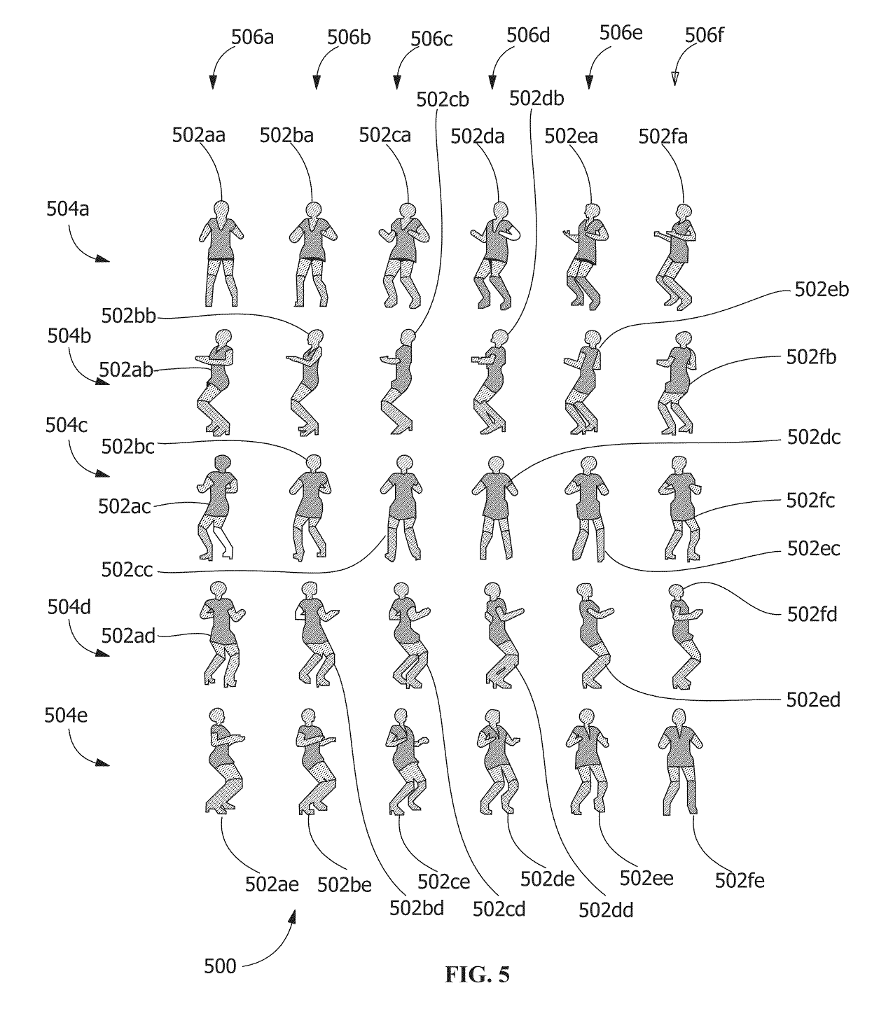

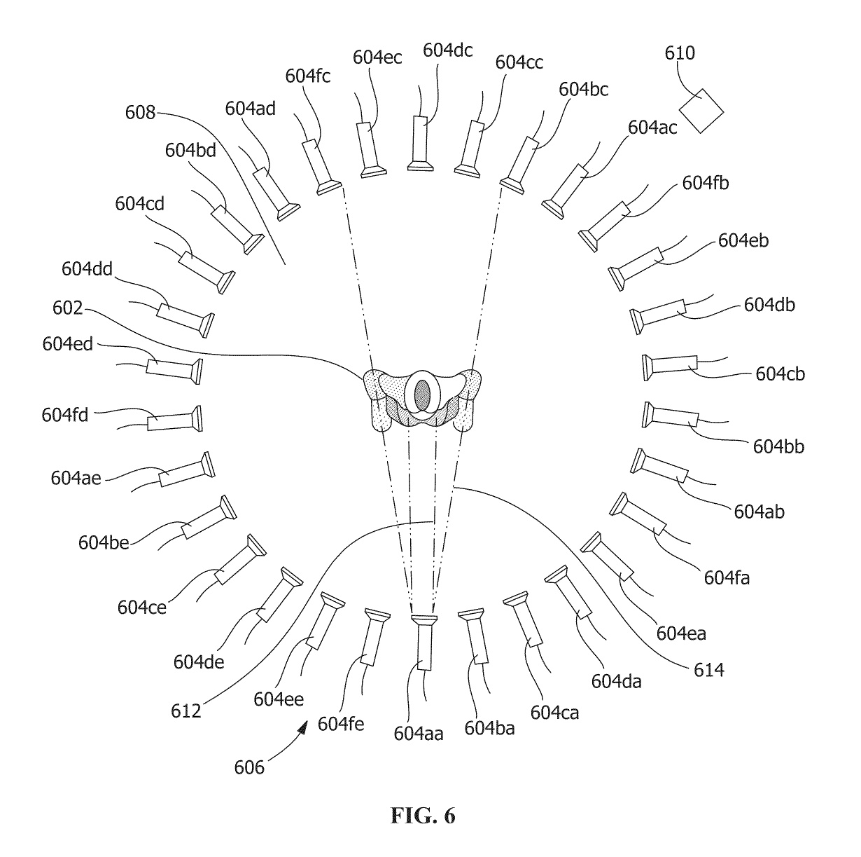

As shown in FIG. 4, the three-dimensional image 302 is capable of being viewed from any direction, for example, by an audience 402 positioned around the three-dimensional image 302 at a concert. In one embodiment, the three-dimensional image 302 is capable of being viewed from around the three-dimensional image 302, above the three-dimensional image 302, at an angle above or below the three-dimensional image 302, or combinations thereof. The viewing is capable of being directed to a specific region or all directions. In one embodiment, as is further described below with reference to FIG. 6, the viewing corresponds to orientation of visual detectors 604, such as cameras, arranged in an array 606 (for example, a concentric array) around an object 602 that is reproduced as the three-dimensional image.

Referring again to FIG. 3, in one embodiment, the three-dimensional display device 100 includes the cover 304 for preventing interruption of rotation. In embodiments used in a concert, stadium, theatrical, or commercial displays, this permits operation closer to individuals that may otherwise interrupt display of the three-dimensional image 302. In one embodiment, the three-dimensional image 302 is larger than a life-sized display of a human. In this embodiment, the three-dimensional display device 100 is capable of being used in any event (such as a concert, sporting event, theatrical event, ornamental display, advertisement, holiday/Christmas light displays, or lecture event) for additional viewing enjoyment, to remedy obstructed viewing at any events, to further facilitate communication, or any other suitable enhancement of viewing. In one embodiment, the three-dimensional display device 100 is totally contained and unable to be accessed by unauthorized individuals. In this embodiment, the three-dimensional display device 100 is capable of being operated remotely or on a continuous loop. For example, in one embodiment, the three-dimensional image 302 is a life-sized display of a human. In this embodiment, the three-dimensional display device 100 is capable of being used as an advertising display, a virtual receptionist, a virtual bank teller, an interactive computer-operated display, a virtual teacher, or any other suitable virtual being or object. In one embodiment, the three-dimensional image 302 is smaller than a life-sized display of a human. For example, in a further embodiment, as shown in FIG. 8, the three-dimensional display device 100 is a hand-held device capable of individual viewing. In this embodiment, the three-dimensional display device 100 is capable of being used as a communication tool, a teaching tool, a novelty item, or any other suitable portable device. In a further embodiment, features for such portability are included, such as, collapsibility of the rotatable portion 106, the light emitting elements 102, the protruding members 104, or combinations thereof. For example, in one embodiment, the light emitting elements 102 and the protruding members 104 are flexible or jointed, and the rotatable portion 106 collapses to within the non-moving portion 108 of the three-dimensional display device 100 when not operating. In another embodiment, the rotatable portion 106 is flexible or jointed, and capable of being positioned within the non-moving portion 108 of the three-dimensional display device 100. In this embodiment, as shown in FIG. 9, the three-dimensional display device 100 is operated with the rotatable portion 106 extending downward (in the direction of gravity) from the non-moving portion 108. Referring again to FIG. 7, in one embodiment, the rotatable portion 106 includes a square cross section, but in alternative embodiments, the cross section can be any suitable geometric shape such as circular, rectangular, oval, or combinations thereof.

Referring to FIG. 5, in one embodiment, the three-dimensional image 302 (see FIG. 3) is formed from a sequence 500 of segmented images 502 corresponding with segmented image data. The amount of the segmented images 502 used is any suitable number. Use of a greater amount of images desirably increases results in a more accurate depiction of the three-dimensional image 302 but utilizes more memory and/or requires a higher data transmission rate because it involves more data. Use of a lesser amount of images distorts the form of the three-dimensional image 302 but desirably uses less memory and/or utilizes a lower data transmission rate because it involves less data. The amount of segmented images 502 corresponds with an amount of the visual detectors 604 (see FIG. 6) used to capture image data or differs from the amount of the visual detectors 604 used to capture image data. Suitable amounts of segmented images 502 include, but are not limited to, three segmented images 502, four segmented images 502, eight segmented images 502, twelve segmented images 502, fifteen segmented images 502, twenty segmented images 502, twenty-four segmented images 502, thirty segmented images 502 (as is shown in FIG. 5), thirty-two segmented images 502, thirty-six segmented images 502, forty eight segmented images 502, or more segmented images 502. In one embodiment, data corresponding to the segmented images 502 is transmitted to the three-dimensional display device 100 and the three-dimensional image 302 is displayed without manipulation of the data and/or display of images corresponding to the data.

In one embodiment, the segmented images 502 are arranged and/or displayed corresponding to a position relative to the object 602 (as shown in FIG. 6) that is to be displayed as the three-dimensional image 302 (as shown in FIG. 3). For example, as shown in FIG. 5, in one embodiment, the sequence 500 includes rows 504 and columns 506 permitting identification of specific portions of the sequence 500. In one embodiment, the rows 504 and/or columns 506 are identified numerically to facilitate operational communication of the three-dimensional display device 100. For example, in one embodiment, the rows 504 are identified by a first row 504a, a second row 504b, a third row 504c, a fourth row 504d, and a fifth row 504e and/or the columns 506 are identified by a first column 506a, a second column 506b, a third column 506c, a fourth column 506d, a fifth column 506e, a sixth column 506f, or any other suitable nomenclature. Identification of each of the rows 504 and the columns 506 permits identification of each of the segmented images 502 through a binomial (for example, segmented image 502aa, 502ab, 502ac, 502ad, 502ae, 502af, 502ba, 502bb, 502bc, 502bd, 502be, 502bf, 502ca, 502cb, 502cc, 502cd, 502ce, 502cf, 502da, 502db, 502dc, 502dd, 502de, 502df, 502ea, 502eb, 502ec, 502ed, 502ee, and 502ef).

Referring to FIG. 6, in one embodiment, the sequence 500 of the segmented images 502, described above with reference to FIG. 5, corresponds to the visual detectors 604, such as cameras, in the array 606 (for example, a concentric array) around the object 602, such as a performer. In one embodiment, each of the visual detectors 604, is mapped to correspond to each of the segmented images 502 with a corresponding binomial (for example, visual detector 604aa, 604ab, 604ac, 604ad, 604ae, 604af, 604ba, 604bb, 604bc, 604bd, 604be, 604bf, 604ca, 604cb, 604cc, 604cd, 604ce, 604cf, 604da, 604db, 604dc, 604dd, 604de, 604df, 604ea, 604eb, 604ec, 604ed, 604ee, and 604ef). The visual detectors 604 are any suitable device for capturing images or data associated with images. Suitable visual detectors 604 include, but are not limited to, color cameras, grayscale cameras, infrared cameras, motion detectors, light measuring devices, temperature measuring devices, three-dimensional cameras, two-dimensional cameras, any suitable spectroscopic device, or combinations thereof. In one embodiment, one or more of the visual detectors 604 are replaced with one or more mirrors or other reflective surfaces.

In one embodiment, the array 606 is arranged with the visual detectors 604 being positioned in a single plane. In this embodiment, the segmented images 502 generated are capable of being automatically aligned and transmitted as data to the three-dimensional display device 100 where the three-dimensional image 302 is displayed through illumination, colored illumination, and/or color transition of the light emitting elements 102 in the protruding members 104. In another embodiment, the array 606 includes one or more of the visual detectors 604 being outside of the plane of one or more of the visual detectors 604. In this embodiment, the alignment of the segmented images 502 is correlated (for example, based upon previous calculations) and a more vivid display of the three-dimensional image 302 is generated. In one embodiment, the array 606 includes the visual detectors 604 aligned in more than one plane (or at least one of the visual detectors 604 is not positioned in a single plane), thereby creating additional visual lines for individuals viewing the object 602.

The visual detectors 604 within the array 606 are arranged at one or more predetermined angles with respect to a surface, such as a stage 608 (see FIG. 6). For example, in one embodiment, all of the visual detectors 604 are at the same angle with respect to the surface, some of the visual detectors 604 are at the same angle with respect to the surface, or each of the visual detectors 604 is at a different angle with respect to the surface. Suitable angles include, but are not limited to, 0 degrees (for example, parallel to the stage 608), 10 degrees (for example, aiming from an edge of the stage 608), 20 degrees, 30 degrees, 45 degrees, 60 degrees, or any range within.

The visual detectors 604 within the array 606 are arranged at one or more elevations in comparison to the surface (for example, a distance between the stage 608 and the visual detector 604). For example, in one embodiment, all of the visual detectors 604 are at the same elevation with respect to the surface, some of the visual detectors 604 are at the same elevation with respect to the surface, or each of the visual detectors 604 is at a different elevation with respect to the surface. Suitable elevations are relative or quantified. For example, in one embodiment, one or more of the visual detectors 604 is positioned below the surface (for example, angled up from beyond the surface, such as the stage 608), at zero elevation (for example, from the surface, such as the stage 608), at about one-third the height of the object 602 relative to the surface, at about one-half the height of the object relative to the surface, at about two-thirds the height of the object 602 relative to the surface, at about the height of the object 602, above the height of the object 602, or combinations thereof.

Adjustment of the position and orientation of the visual detectors 604 with respect to the surface and/or the object 602 permits a more complete representation of the object 602 to be displayed in the three-dimensional image 302. In addition, the position and orientation of the visual detectors 604 permits data of the segmented images 502 to be displayed by the three-dimensional display device 100 without data manipulation, such as interpolation, morphing, and/or dissolving. In one embodiment, the three-dimensional display device 100 is capable of displaying the three-dimensional image 302 in real-time or substantially real-time from a live feed, for example, with little or no manipulation of image data. In another embodiment, the three-dimensional display device 100 is capable of displaying the three-dimensional image 302 that is provided as a result of playback of pre-recorded image data, for example, with little or no manipulation of the image data.

In one embodiment, the visual detectors 604 are arranged with one or more theatrical devices 610 capable of modifying the view of the object 602. For example, in one embodiment, one or more of the theatrical devices 610 is a strobe light, a smoke machine, a laser, a light, or any suitable combination thereof. Use of the theatrical devices 610 permits additional effects to be shown in the display of the three-dimensional image 302. In one embodiment, the strobe light is at a rate corresponding to an image capture rate for the visual detectors 604 and/or an image display rate of the light emitting elements 102 and/or the three-dimensional display device 100. Suitable image capture rates include, but are not limited to, about 3 frames per second, about 8 frames per second, about 15 frames per second, about 20 frames per second, about 24 frames per second, about 30 frames per second, about 60 frames per second, about 100 frames per second, about 600 frames per second, about 1000 frames per second, or any suitable sub-range within. Suitable image display rates are slower than, quicker than, or equal to the image capture rates. Suitable image display rates include, but are not limited to, about 3 frames per second, about 8 frames per second, about 15 frames per second, about 20 frames per second, about 24 frames per second, about 30 frames per second, about 60 frames per second, about 100 frames per second, about 600 frames per second, 900 frames per second, about 1000 frames per second, or any suitable sub-range within. In one embodiment, the three-dimensional display device 100 rotates at a revolution rate corresponding to the image capture rate and/or the image display rate, for example, at about one-half of the image capture rate and/or the image display rate, one-third of the image capture rate and/or the image display rate, two-thirds of the image capture rate and/or the image display rate, or any other suitable ratio.

Referring again to FIG. 6, image data is captured corresponding to the object 602 to be displayed as the three-dimensional image 302 (see FIG. 3). The captured image data is capable of being viewed (for example, during or after the capturing to monitor quality) or is not capable of being viewed (for example, being transmitted without any viewing option). The captured image data includes segmented data corresponding to each of the visual detectors 604. In one embodiment, the segmented data is truncated such that the segmented data represents a rectangular data column (for example, corresponding to a rectangular region 612 in front of the visual detector 604 as is shown in FIG. 6) having peripheral data (not shown) eliminated (for example, corresponding to a peripheral region 614 angling from the visual detector 604 as is shown in FIG. 6). In one embodiment, the segmented data of the captured image data is correlated to position information about the object 602, such as, distance from one or more of the visual detectors 604.

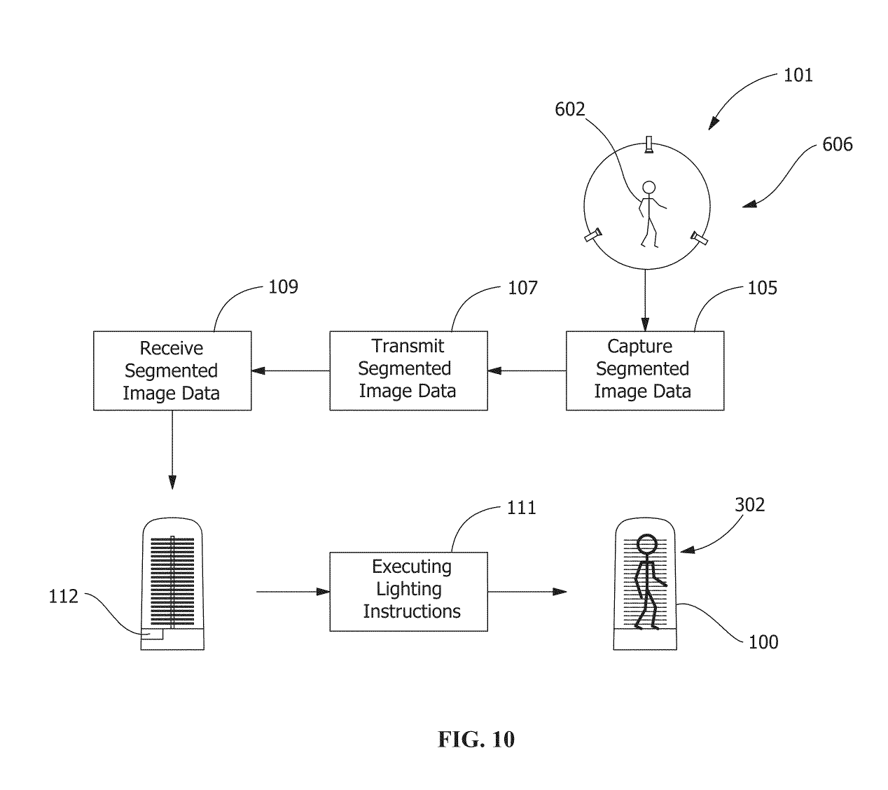

FIG. 10 schematically shows a system 101 capable of performing a process 103 for displaying the three-dimensional image 302. The system includes the array 606 of the visual detectors 604 and the device 100. The array 606 captures image data (step 105), including segmented images. The image data is transmitted (step 107) from the array 606, directly or indirectly, and received (step 109) by the device 100 and/or a control system 112, where the image data is utilized to execute lighting instructions (step 111) resulting in the illusion of the three-dimensional image 302. The transmission is through any suitable methods, including, but not limited to, wireless (such as, through an infrared, radiofrequency, or any other electromagnetic signal) or wired (such as, through a fiber-optic cable, a coaxial cable, an RCA cable, or any other suitable electrically communicative mechanism). The control system 112 is any suitable control system.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A three-dimensional display device, comprising:
a rotatable portion; and
a plurality of light emitting elements connected to the rotatable portion;
wherein rotation of the rotatable portion rotates the light emitting elements, thereby displaying an illusion of a three-dimensional image corresponding to a sequence of segmented images.

2. The device of claim 1, wherein the light emitting elements include light emitting diodes.

3. The device of claim 1, wherein the sequence of images correspond to an array of cameras.

4. The device of claim 1, wherein the segmented image data changes over time and corresponds to an object in motion.

5. The device of claim 1, wherein the segmented image data is real-time data from a live feed.

6. The device of claim 1, wherein the segmented image data is playback of pre-recorded image data.

7. The device of claim 1, wherein the light emitting elements are positioned on protruding members extending from the rotatable portion.

8. The device of claim 7, wherein one or more of the protruding members is rigidly secured to the rotatable portion.

9. The device of claim 7, wherein one or more of the protruding members is flexibly secured to the rotatable portion.

10. The device of claim 7, wherein the protruding members are arranged in a substantially uniform orientation around the rotatable portion.

11. The device of claim 7, wherein a first protruding member of the protruding members extends at a first angle from the rotatable portion and a second protruding member of the protruding member extends at a second angle from the rotatable portion, the first angle differing from the second angle.

12. The device of claim 1, wherein the light emitting elements display data captured from two or more visual detectors.

13. The device of claim 12, wherein the two or more visual detectors are selected from the group consisting of one or more color cameras, one or more grayscale cameras, one or more infrared cameras, one or more motion detectors, one or more light measuring devices, one or more temperature measuring devices, one or more three-dimensional cameras, one or more two-dimensional cameras, one or more spectroscopic measurement devices, or a combination thereof.

14. The device of claim 12, wherein each of the two or more visual detectors are positioned in a single plane.

15. The device of claim 12, wherein at least one of a first visual detector of the two or more visual detectors, a second visual detector of the two or more visual detectors, a third visual detector of the two or more visual detectors, and a fourth visual detector of the two or more visual detectors is not positioned in a single plane.

16. The device of claim 12, wherein each of the two or more visual detectors are at the same angle and elevation with respect to a portion of the rotatable portion.

17. The device of claim 12, wherein a first visual detector of the two or more visual detectors is at a first angle and a first elevation with respect to a portion of the rotatable portion and a second visual detector of the two or more visual detectors is at a second angle and a second elevation with respect to the portion of the rotatable portion.

18. The device of claim 1, wherein the rotatable portion rotates at a revolution rate corresponding to about one-half an image display rate, the image display rate being about 900 frames per second.

19. The device of claim 18, wherein an image capture rate is about 30 frames per second.

20. A system for creating a three-dimensional display, the system comprising:
an array arranged and disposed to gather segmented image data, and
a device arranged and disposed to display a sequence of images corresponding with the segmented image data;
wherein the displaying forms an illusion of a three-dimensional image.

21. A process of creating a three-dimensional display, the process comprising:
gathering segmented image data, and
displaying a sequence of images corresponding with the segmented image data;
wherein the displaying forms an illusion of a three-dimensional image.
